(19) United States
(12) Patent Application Publication
(10) Pub. No.: US 2023/0256453 A1
(43) Pub. Date: Aug. 17, 2023

(54) BEAD MILL

(71) Applicant: HIROSHIMA METAL & MACHINERY CO., LTD., Tokyo (JP)

(72) Inventors: Tetsuharu Ibaraki, Kure-shi Hiroshima (JP); Kaoru Yamaguchi, Kure-shi Hiroshima (JP); Kazuyuki Natsumeda, Kure-shi Hiroshima (JP); Daisuke Hirata, Kure-shi Hiroshima (JP); Kouji Senda, Kure-shi Hiroshima (JP)

(73) Assignee: HIROSHIMA METAL & MACHINERY CO., LTD., Tokyo (JP)

(21) Appl. No.: 18/134,265

(22) Filed: Apr. 13, 2023

Related U.S. Application Data
(63) Continuation of application No. PCT/JP2021/032041, filed on Sep. 1, 2021.

(30) Foreign Application Priority Data
Oct. 15, 2020 (JP) 2020-173771

(51) Int. Cl. B02C 17/16; B02C 17/04

(52) U.S. Cl. CPC B02C 17/163; B02C 17/04; B02C 17/161

(57) ABSTRACT

Problems occur in a bead mill due to wear on a sealing member of a sealing device disposed on a contact portion between a rotating portion and slurry, and due to the adhesion of deposits on the sealing device. A bead mill device that stirs a mixture of slurry and beads in a vertical cylindrical container includes a slurry storage vessel disposed above the cylindrical container, and a slurry flow passage through which the slurry flows from the slurry storage vessel into the cylindrical container. A component that causes the slurry in the slurry flow passage to flow downward is disposed on a rotary shaft. Further, a component for suppressing the flow of the slurry is disposed in the slurry storage vessel. This structure obviates the need to dispose a mechanical sealing device on the rotary shaft.

### TECHNICAL FIELD

The present invention relates to a bead mill that performs pulverization and dispersion processing on particles in a suspension of solid particles (referred to hereinafter as slurry) by stirring hard particles (referred to hereinafter as beads) serving as a stirring medium in a container.

### BACKGROUND ART

A high-pressure jet mill, an ultrasonic homogenizer, a bead mill, and so on are available as devices for pulverizing and dispersing microparticles in slurry. Of these devices, a bead mill is capable of continuous processing and, due to being capable of pulverization and dispersion from micrometer size to nanometer size and so on, exhibits superior pulverization and dispersion functions. A bead mill is a device (a bead mill) in which a rotary member (a stirring rotor) rotates at high speed in a tightly sealed cylindrical container so that shearing force is generated between the cylindrical container and the stirring rotor, with the result that the particles in the slurry are pulverized and dispersed by the impact force of the beads suspended in the slurry.

For example, in a device (a bead mill 1) of an invention disclosed in the Patent Literature 1, a stirring rotor is provided in a lower portion of a cylindrical container, and by rotating the stirring rotor, pulverization processing is performed on particles and dispersion processing is performed on secondary particles formed from agglomerations of primary particles. To implement the pulverization and dispersion efficiently, the processing is performed by intermixing beads with a diameter of approximately 0.05 to 5 mm into the slurry. In the bead mill 1, the beads are separated from the slurry on which the pulverization and dispersion processing has been completed by a bead separation device provided in an upper portion. Further, in a bead mill (a bead mill 2) described in Patent Literature 2, a mixture of slurry and beads is stirred inside a cylindrical container by a large bead separation device instead of a stirring rotor.

In a bead mill having this type of bead separation mechanism, pressure loss occurs in the device, e.g., when the slurry flows through a bead filling layer and when the slurry flows against centrifugal force generated as the bead separation device rotates, and therefore, in order to cause the slurry to flow through the bead mill having this type of bead separation device, it is necessary to apply comparatively high pressure of 0.1 to 0.4 MPa inside the mill.

Here, the pulverization processing refers to dividing single particles into a plurality of particles, while the dispersion processing refers to establishing a state in which primary particles are individually dispersed by separating secondary particles constituted by a plurality of particles. Note that the primary particles are individual crystalline or non-crystalline particles of a substance, and the secondary particles are formed when the surfaces of typically several to several thousand primary particles contact each other so as to form pseudo-particles. The beads used in the pulverization processing and dispersion processing are particles formed from a ceramic such as alumina or zirconia, a metal such as stainless steel, or plastic, and range in size from several tens of micrometers to several millimeters. The beads are generally preferably spherical.

### CITATION LIST

### Patent Literature

[Patent Literature 1] Japanese Patent Application Publication No. 2002-143707
[Patent Literature 2] Japanese Patent Application Publication No. 2017-131807

### SUMMARY OF INVENTION

### Technical Problem

As noted above, a bead mill is capable of continuous processing and, due to being capable of pulverization and dispersion from micrometer size to nanometer size and so on, exhibits superior pulverization and dispersion functions. However, a bead mill has the following problems.

In a bead mill, the particles in the slurry are subjected to pulverization processing or dispersion processing by stirring the beads in a cylindrical container, and the beads are separated inside the cylindrical container. As described above, however, the push-in pressure applied thereto is high, while on the other hand, since a rotary driving portion of a rotary shaft for rotating the stirring rotor inside the cylindrical container comes into contact with the slurry, a rotating portion seal is required to prevent liquid leakage. To realize this rotating portion seal in the part where the pressure is comparatively high, a sealing structure realized by a mechanical sealing device is typically used.

A sealing device such as a mechanical seal is required to prevent slurry in a high-pressure container having a contact portion between a fixed component and a rotating component from leaking to the outside through a seal portion. To prevent leakage, it is necessary to apply pressure to the outside of the sealing device, and a mechanical seal is structured so as to house a sealing liquid. The seal contact portion component gradually becomes worn, which causes a problem in that the sealing performance deteriorates over time. As a result, a problem occurs in that the sealing liquid leaks into the slurry so as to contaminate the slurry. Another problem is that wear debris from the seal contact portion component (metal, ceramic, or the like) intermixes with the slurry. Furthermore, when the wear on the sealing device becomes severe, the sealing device has to be replaced, which costs money. Sealing portion wear occurs to a particularly large degree in slurry containing metal powder such as nickel, and this is a serious problem.

Another problem of a sealing device is that a mechanical seal has a complicated structure including a plurality of components, which is due to the existence of seams and uneven portions. In a bead mill having a sealing device, a problem occurs in that the slurry adheres to the seams and uneven portions. Especially when processing raw materials for foodstuffs and pharmaceuticals, problems occur in that due to putrefaction of solid matter, the product slurry cannot be used as a commercial product, and due to poor cleaning, the slurry is contaminated after changing the product type. Hence, problems occur due to wear of the sealing device and adhered substances, and therefore new technology for solving these problems is required.

### Solution to Problem

(1) A bead mill device having a rotary shaft disposed in a vertical direction includes a slurry storage vessel disposed above a container that processes slurry using beads. A slurry passage hole is disposed in a lower portion of the container, and a slurry flow passage through which the slurry can pass is disposed between an upper lid of the container and the slurry storage vessel. Further, the rotary shaft extends from above the slurry storage vessel through a space in the slurry flow passage into the container. Furthermore, a mechanism that causes the slurry in the slurry flow passage to flow downward is provided on the rotary shaft, and a swirl promoting component that swirls the slurry as the rotary shaft rotates is disposed in a higher position than a stirring rotor or a centrifugal bead separation device disposed in an uppermost portion of the cylindrical container.

(2) The bead mill having the structure described above in (1) is structured such that the slurry is supplied through the slurry passage port disposed in the lower lid of the cylindrical container, whereby the slurry flows upward. A centrifugal bead separation device is disposed on the rotary shaft in a position in an upper portion of the container. Further, a hollow passage through which the slurry that has passed through the centrifugal bead separation device flows out into the slurry storage vessel is disposed in the interior of the rotary shaft.

(3) In the bead mill described above in (2), a flow passage fixed to a slurry outlet of the hollow passage formed in the rotary shaft causes the slurry to flow in a direction away from the rotational center of the rotary shaft and discharges the slurry into the slurry in the slurry storage vessel so that the slurry flow is suctioned from the slurry outlet by centrifugal force.

(4) In the bead mill described above in (2) or (3), a screen that filters the rising slurry so as to separate the beads is disposed in the slurry in the slurry storage vessel.

(5) In the bead mill described above in (4), a component that causes the slurry in a space between the screen and the rotary shaft to flow downward and/or a component for swirling the slurry below the screen is disposed on the rotary shaft.

(6) In the bead mill of (2) or (3) above, a partition plate that divides the slurry stored in the slurry storage vessel into upper and lower parts is disposed, the partition plate has an opening portion through which the rotary shaft passes vertically, and a component for swirling the slurry is disposed on the rotary shaft below the opening portion.

(7) The bead mill described above in (1) is structured such that after the slurry is supplied from the slurry storage vessel into the cylindrical container through the slurry flow passage and then stirred together with the beads in the cylindrical container, the beads are separated by a contact-type bead separation device, whereupon the slurry is discharged through the slurry passage port.

(8) In the bead mill described above in any of (1) to (7), a component for preventing swirling of the slurry is disposed in the slurry in the slurry storage vessel.

(9) In the bead mill described above in (8), the component for preventing slurry rotation, disposed in the slurry storage vessel, is constituted by a plurality of vertical direction plates arranged so as to divide the interior of the slurry storage vessel in a circumferential direction.

(10) In the bead mill described above in (8), the component for preventing slurry rotation, disposed in the slurry storage vessel, is constituted by a combination of a structure that surrounds the rotary shaft and has a cylindrical shape, a polygonal shape, or another shape, and a vertical direction plate disposed so as to divide the interior of the slurry storage vessel in a circumferential direction.

(11) In the bead mill described above in any of (2) to (6), the diameter of an outermost peripheral portion of the swirl promoting component that swirls the slurry in the uppermost portion of the cylindrical container is at least 0.82 times that of an outermost peripheral portion of a component of the centrifugal bead separation device that swirls the slurry.

### Advantageous Effects of Invention

The bead mill of the present invention does not include a rotating portion sealing device that contacts the slurry, and therefore the problem caused by wear of the contact members of the rotating portion sealing device, namely contamination of the product slurry with debris from the worn sealing components and the sealing liquid, is eliminated. The problem of particles in the slurry adhering to the rotating portion sealing device, making cleaning difficult, can also be solved.

### BRIEF DESCRIPTION OF DRAWINGS

FIG. 1 is an example of a device of the present invention, which includes a centrifugal bead separation device and in which a bead outflow prevention screen and a rotating component that sucks out slurry fixed to a rotary shaft using centrifugal force are disposed in a slurry storage vessel.

FIG. 2 is an example of a device of the present invention, which includes the centrifugal bead separation device and in which the bead outflow prevention screen, a component for suppressing slurry rotation, and a component for rotating the slurry below the screen are disposed in the slurry storage vessel.

FIG. 3 is an example of a device of the present invention, which includes a contact-type bead separation device having a gap that is narrower than the bead diameter, and in which the component for suppressing slurry rotation is disposed in the slurry storage vessel.

FIG. 4 is a view showing an example of a component that is disposed in the device of the present invention and has a function for causing the slurry to flow downward.

FIG. 5 is a view showing an example of a component that is disposed in the device of the present invention and has a function for causing the slurry to flow downward.

FIG. 6 is a view showing structural examples of a component (swirling blades 13) having a function for swirling the slurry in an upper portion of a cylindrical container, and an under-screen swirling component 20.

FIG. 7 is a structural example of a flow passage disposed in a slurry outlet of a rotary shaft inner flow passage of the rotary shaft in order to swirl the slurry flow.

FIG. 8 is a structural example of a centrifugal bead separation device fixed to the rotary shaft.

### DESCRIPTION OF EMBODIMENTS

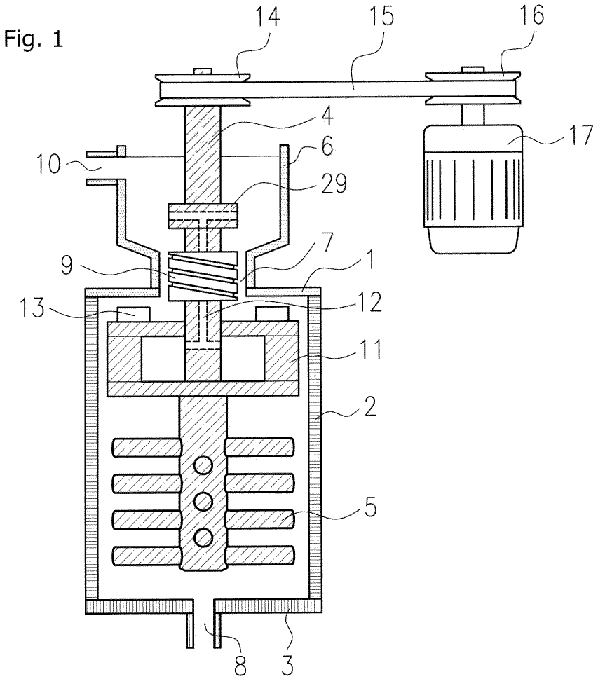

FIGS. 1, 2, and 3 show a structural outline of a device of the present invention. The device is a bead mill in which a stirring rotor 5 rotates inside a cylindrical container constituted by a cylinder 2, an upper lid 1, and a lower lid 3. A rotary shaft 4 is disposed in a vertical direction, and a slurry storage vessel 6 is provided above the cylindrical container. Note that the direction of the rotary shaft 4 does not have to be a perfectly vertical direction and may be inclined by up to approximately 15 degrees. The cylindrical container and the slurry storage vessel 6 are connected by a slurry flow passage 7 through which slurry passes, and the rotary shaft 4, which is rotated by a driving device disposed above the cylindrical container, extends through the slurry storage vessel 6 and the slurry flow passage 7 into the cylindrical container. The stirring rotor 5 is fixed to the rotary shaft 4 in order to stir a mixture of slurry and beads in the cylindrical container. Further, a liquid feeding component that causes the slurry in the slurry flow passage 7 to flow downward is fixed to the rotary shaft 4. The liquid feeding component is disposed either in the interior of the slurry flow passage 7 or in an uppermost portion of the cylindrical container. Due to the action of the liquid feeding component, a downward flow is formed in the slurry flow passage 7, and as a result, leakage of the beads intermixed in the slurry in the cylindrical container can be prevented without the need for a sealing structure between the rotary shaft 4 and a fixed member (the upper lid 1).

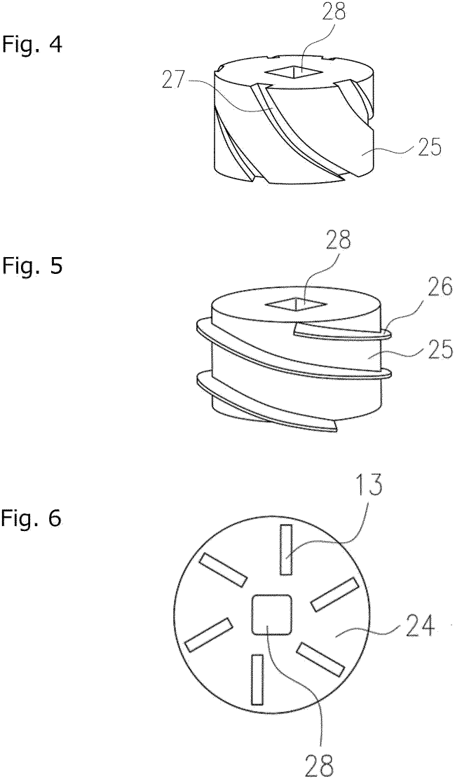

In FIGS. 1 to 3, a pumping component 9 that has a columnar shape with grooves formed therein and is provided in the interior of the slurry flow passage 7 is illustrated as an example of a suitable component shape for the liquid feeding component. FIG. 4 shows a detailed example of the structure thereof, in which grooves 27 are formed in a columnar portion 25. Alternatively, as shown in FIG. 5, a spiral projection 26 may be formed on the columnar portion 25. The liquid feeding component does not necessarily have to be this shape, and any axial flow-type pumping mechanism may be used. Further, FIGS. 1, 2 and 3 illustrate a system in which a swirl promoting component (swirling blades 13) for swirling the slurry is provided in the uppermost portion of the cylindrical container together with the pumping component 9, and by causing the slurry to flow from a central portion to a peripheral portion using the swirl promoting component, the beads are pushed out to an outer peripheral portion of the cylindrical container by centrifugal force, while the slurry is sucked out from the slurry flow passage 7.

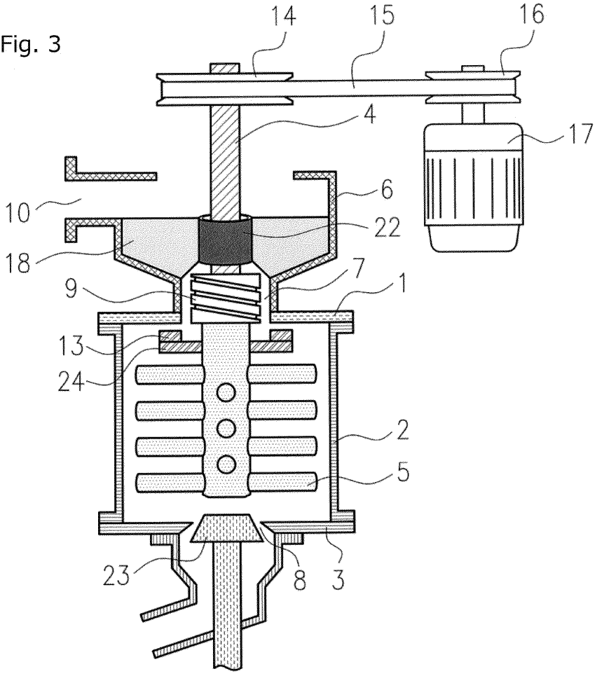

FIG. 6 shows a specific example of this structure. FIG. 6 is a view showing the component from above, and illustrates an example in which rectilinear plates having receding angles in a rotation direction are disposed on an upper portion of a disc 24 as the swirling blades 13. The swirling blades 13 may be rectilinear or curved. The swirling blades 13 preferably have a receding angle (10 to 45 degrees) in the rotation direction. Note that when curved plates are used, the angle of the outermost part is viewed as the receding angle. Further, the component for swirling the slurry does not have to take the form of the swirling blades 13, and instead, for example, a component having a plurality of grooves formed in a disc or, in the case of FIG. 3, a component formed from only the swirling blades 13 without the disc 24 may be used. Moreover, as long as a function for swirling the slurry so that the slurry flows from the central portion toward the outer peripheral portion is realized, another shape may be used. Furthermore, as long as the upper portion of the cylindrical container includes a structure with which a sufficient downward flow is formed in the slurry flow passage 7 by the swirl promoting component for swirling the slurry, the liquid feeding component in the slurry flow passage 7, such as the pumping component 9, may be omitted so that only the swirl promoting component for swirling the slurry is disposed in the uppermost portion of the cylindrical container. By rotating the slurry in the upper portion of the cylindrical container at high speed, the slurry in the central portion is pushed out to the peripheral portion, and as a result, an effect of suctioning the slurry in the slurry flow passage 7 is realized.

In the device of the present invention, due to the effects of the rotary motion of the slurry in the cylindrical container and the rotation of the rotary shaft 4, a vortex may be formed in the slurry storage vessel 6 such that the liquid surface enters the slurry flow passage 7. In this case, air enters the mill, causing problems such as a reduction in the stirring efficiency of the beads and foaming of the slurry. These problems are particularly likely to occur when the stirring rotor 5 rotates at high speed or when highly viscous slurry is processed. In response to these problems, a component for preventing the slurry in the slurry storage vessel 6 from swirling may be disposed.

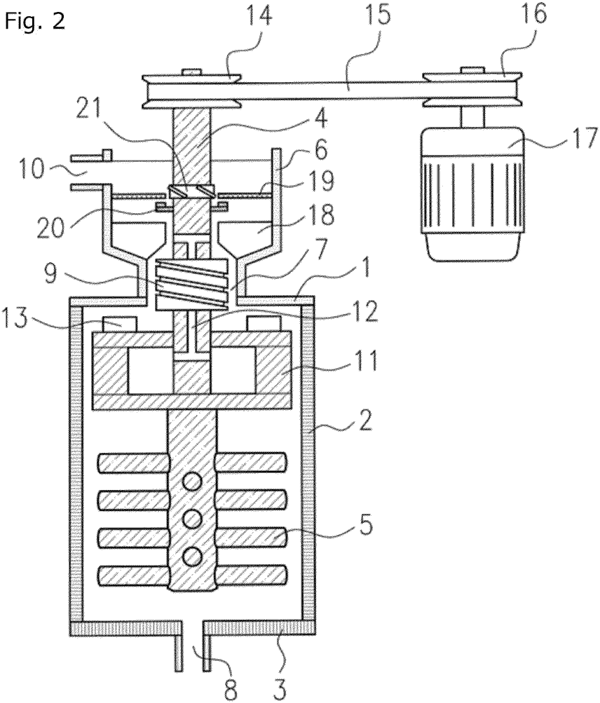

The component for suppressing swirling of the slurry may take any shape as long as swirling can be suppressed, but for example, a component (swirl prevention plates 18) shown in FIGS. 1 and 2, in which a plurality of partition plates are disposed in a radial direction in order to halt rotation, is structurally simple and highly effective. The number of plates is preferably from 3 to 12. Further, in addition to the swirl prevention plates 18, as shown in FIG. 3, a tube (a swirl prevention tube 22) having a cylindrical shape, a polygonal shape, or another shape may be disposed around the rotary shaft 4 so as to reduce the effect of the rotation of the rotary shaft 4 on the slurry flow. Alternatively, although less effective, a comb tooth-shaped component may be disposed in the slurry in the slurry storage vessel 6, for example, in order to suppress swirling of the slurry by creating flow resistance.

The bead mill of the present invention uses two methods. In method 1, as shown in FIGS. 1 and 2, a centrifugal bead separation device is provided in the cylindrical container, and the slurry is supplied through a slurry passage port 8 in the lower lid 3 of the cylindrical container. The centrifugal bead separation device may take any form, but a centrifugal bead separation device used in experiments conducted by the inventors was a centrifugal bead separation device 11 shown in FIG. 1 or, as shown in detail in FIG. 8, a device in which a plurality of plates (bead separation plates 33) are fixed to an upper/lower pair of discs (an upper fixing disc 31 and a lower fixing disc 32). The bead separation plates 33 were arranged at intervals of 10 to 40 mm between the outer peripheral portions thereof, and each had a receding angle of 10 to 40 degrees in the rotation direction. Instead of the form described above, a centrifugal bead separation device having a spiral impeller or the like can also be used in the present invention. In method 2, the slurry passage port 8 in the lower lid 3 is used for slurry discharge, and in this case, a slit-type or screen-type bead separation device, such as a slit-type bead separation device 23 shown in FIG. 3, is disposed. The slurry flows downward from the upper portion, whereupon the beads are separated and the slurry is discharged to the outside of the mill.

First, the bead mill of method 1 will be described in detail. A feature of this type is a structure including a component that causes the slurry to flow downward through the slurry flow passage 7 and a component that forms a slurry flow from the center toward the periphery in the slurry between the upper surface of the centrifugal bead separation device 11 and the upper lid 1 and prevents bead leakage by applying centrifugal force. By employing this structure, a bead mill not having a sealing structure in the rotating portion is formed. Note that in FIGS. 1 and 2, the stirring rotor 5 is disposed below the centrifugal bead separation device 11, but the centrifugal bead separating component may itself be provided with a stirring function, and in this case, the stirring rotor 5 may be omitted.

In the example of FIG. 1, which shows an embodiment of method 1 of the present invention, after performing stirring processing on the mixture of the slurry and the beads in the cylindrical container, the beads are separated from the slurry using centrifugal force. The centrifugal bead separation device 11 is fixed to the rotary shaft 4. The slurry from which the beads have been separated by centrifugal force passes through a rotary shaft inner flow passage 12 formed in the interior of the rotary shaft 4, and is discharged into the slurry storage vessel 6. Next, the slurry is discharged from the slurry storage vessel 6 to the outside of the device through a slurry communication flow passage 10. Note, however, that the slurry communication flow passage 10 does not necessarily have to be provided, and instead, a structure in which the slurry is sucked up from the slurry storage vessel 6 by a suction pipe or the like may be used. Some of the slurry in the slurry storage vessel 6 is fed downward by the pumping component 9 that is disposed on the rotary shaft 4 and has a function for feeding the slurry downward. By forming a downward flow of slurry in this manner, bead leakage into the slurry flow passage 7 is prevented.

In a case where microbeads of 0.3 mm or less are used or the like, the amount of beads flowing back through the slurry flow passage 7 may increase, and therefore, as shown in FIG. 1, bead leakage into the slurry flow passage 7 must be suppressed by attaching a swirl promoting component such as the swirling blades 13 arranged radially to the upper surface of the centrifugal bead separation device 11 and exerting centrifugal force on the slurry in order to push the beads on the periphery of the slurry flow passage 7 out to the outer peripheral portion of the cylindrical container. The arrangement of the swirling blades 13 in this case is similar to the arrangement shown in FIG. 6. Note that FIG. 6 is a view showing a combination of the swirling blades 13 of method 2 and the upper portion disc 24, but the basic arrangement of the swirling blades 13 is the same. By employing a combination of the pumping component 9 and the swirling blades 13, backflow of the beads due to pressure variation in the mill and so on can be suppressed. Alternatively, a component realized by forming radial grooves in the upper surface of the centrifugal bead separation device 11 or the like may be employed instead, as long as an identical function is realized thereby.

An outer peripheral diameter of the swirling blades 13 is preferably not less than 0.82 times an outermost peripheral diameter of the component of the centrifugal bead separation device 11 that swirls the slurry. More preferably, the outer peripheral diameter is from 0.82 times to 1.48 times the outermost peripheral diameter. These are optimum values for a ratio of the centrifugal force formed by the swirling blades 13 to the centrifugal force formed by the centrifugal bead separation device 11. When the centrifugal force formed by the swirling blades 13 is too strong, the amount of slurry that circulates from the slurry storage vessel 6 to the cylindrical container through the slurry flow passage 7 may become too large, and as a result, the amount of slurry passing through the centrifugal bead separation device 11 may become excessive. Further, when the centrifugal force formed by the swirling blades 13 is too weak, a slurry flow flowing from the upper portion of the cylindrical container into the slurry flow passage 7 is formed. In this case, the component of the centrifugal bead separation device 11 that swirls the slurry may take any shape as long as the slurry is swirled thereby. Note, however, that components that are fixed to a disc or the like and have clear surfaces for pushing and separating the slurry in the rotation direction, such as the bead separation plates 33 shown in FIG. 8, are preferable. The diameter of the outermost peripheral portion is defined as the diameter of the outermost portion of the component that swirls the slurry.

In the device of the present invention shown in FIG. 1, the basic principle for preventing bead leakage according to the present invention is to prevent the slurry from flowing back from the slurry flow passage 7 by adjusting the pressure balance between the centrifugal bead separation device 11 and the swirling blades 13. Depending on the operating conditions of the bead mill, however, disturbances in the flow through the bead mill may increase, causing the slurry to flow back into the slurry flow passage 7. In order to respond to cases of such operating conditions, a component (a swirling slurry discharge component 29) that causes the slurry to flow in a direction away from the rotational center of the rotary shaft 4 may be additionally disposed on the rotary shaft 4 at the outlet portion of the rotary shaft inner flow passage 12, as shown in FIG. 1. By disposing the final outlet of the slurry that flows out of the rotary shaft inner flow passage 12 in a position far from the rotational center, swirling is applied to the slurry flow. Due to the effect of dynamic pressure applied to the swirling slurry flow, a force for suctioning the slurry in the rotary shaft inner flow passage 12 acts thereon. Accordingly, the formation of a flow of slurry flowing into the centrifugal bead separation device 11 is promoted inside the cylindrical container, and as a result, a flow of slurry flowing back through the slurry flow passage 7 is less likely to occur, whereby bead leakage into the slurry storage vessel 6 can be suppressed.

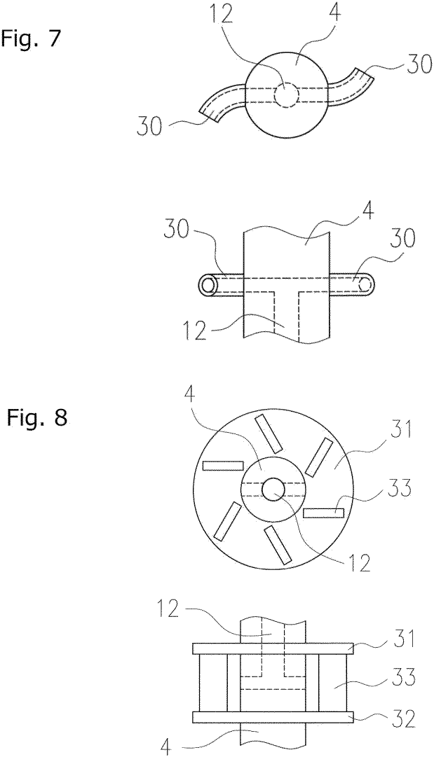

The swirling slurry discharge component 29 may take any form as long as it is structured so as to swirl the slurry flow. However, a structure in which tubes having a circular shape, a square shape, or another shape are disposed at the slurry outlet of the rotary shaft inner flow passage 12, which is divided into 2 to 4 locations, a structure in which a plurality of plates are disposed on an upper/lower pair of discs that apply centrifugal force to the slurry discharged from the rotary shaft inner flow passage 12, or the like is preferable. For example, FIG. 7 shows a structure in which two cylindrical tubes (slurry rotating tubes 30) are disposed at the slurry outlet of the rotary shaft inner flow passage 12. In FIG. 7, slurry outlets are provided in two locations of the rotary shaft inner flow passage 12, and the slurry rotating tube 30 is disposed at each thereof. The slurry rotating tubes 30 are preferably disposed either radially in a diametrical direction from the rotation center, or disposed at receding angles in the rotation direction of the rotary shaft 4. The receding angle is preferably within a range of 0 to 30 degrees. In the example of FIG. 7, the slurry rotating tubes 30 are structured so as to draw an arc that recedes in the rotation direction.

Further, as a structure for applying centrifugal force to the slurry after the slurry is discharged from the rotary shaft inner flow passage 12, an upper/lower pair of circular fixing discs may be disposed on the rotary shaft 4, and a plurality of plates may be disposed thereon so that the slurry is pushed out in the outer peripheral direction by the motion of the plates. This structure is similar to the view of the centrifugal bead separation device shown in FIG. 8. The diameter of the outer peripheral part of the slurry rotating tubes 30, the plates, or the like is affected by the size of the bead mill, the slurry conditions, the diameter of the used beads, and so on, but is preferably 0.3 to 1 times the outer peripheral part of the component of the centrifugal bead separation device 11 that swirls the slurry. Furthermore, the bead separation plates 33 preferably have a receding angle of 10 to 40 degrees relative to the rotation direction.

In the device of the present invention shown in FIG. 2, a component for preventing bead leakage is additionally disposed in the slurry storage vessel 6. Likewise in a bead mill having the structure described above, in which the pumping component 9 and the swirling blades 13 are disposed as basic structures of the present invention, when the slurry is highly viscous, when beads of approximately 0.1 mm are used, and so on, the beads may flow back, albeit in a small amount, through the slurry flow passage 7. As a measure for preventing this phenomenon, a screen 19 is disposed below the slurry liquid surface to prevent the beads from flowing out of the slurry storage vessel 6. Note that when the slurry liquid surface is not flat, a part of the screen 19 may be above the liquid surface. Wire mesh may be disposed over the entire surface of the screen 19 or a part thereof. Gaps in the mesh forming the screen 19 are preferably 0.4 to 1.5 times the bead diameter.

The screen 19 is preferably fixed to the inner surface of the slurry storage vessel 6 so that there is no gap in a contact portion between the screen 19 and the slurry storage vessel 6. However, there is a gap between the screen 19 and the rotary shaft 4, and therefore, depending on the conditions, the beads suspended in the slurry may pass through the gap. When this phenomenon occurs, a component such as an under-screen swirling component 20 or a pumping component 21 is preferably disposed on the rotary shaft 4 to prevent the slurry from rising through the gap. Note that the under-screen swirling component 20 also has the effects of causing the slurry between the rotary shaft 4 and the screen 19 to flow downward and swirling the slurry so that the beads are prevented from approaching the gap between the rotary shaft 4 and the screen 19 by centrifugal force. As long as the under-screen swirling component 20 exhibits a function for causing the slurry to flow outward from the center by rotating, the shape thereof is not limited. A structure in which a plurality of radially arranged linear projections are mounted on a disc, i.e., a similar structure to the disc 24 and the swirling blades 13 disposed in the cylindrical container, as shown in FIG. 6, a structure in which a plurality of radial grooves are formed in a disc as another shape, a structure in which a plurality of plates are arranged on a shaft, and so on may be used. The pumping component 21 is preferably identical to the pumping component 9 shown in FIGS. 4 and 5, for example, so as to be constituted by a groove formed in a cylindrical structure or a screw shape formed from a plurality of blades. Note that FIG. 1 shows both the under-screen swirling component 20 and the pumping component 21, but it is possible to dispose only one thereof.

When the bead leakage suppression function of the under-screen swirling component 20 is sufficient, the slurry does not pass through the screen 19, and bead leakage can be prevented by causing the slurry to pass only through the gap between the screen 19 and the rotary shaft 4. In other words, below the screen 10, the beads are pushed out in an outward direction from an outer peripheral portion of the under-screen swirling component 20 by the centrifugal force of the swirling slurry, and therefore there are no longer any beads in the slurry that rises through the gap between the screen 19 and the rotary shaft 4. As a result of this effect, no beads leak above the screen 19 through the gap. Hence, by providing the under-screen swirling component 20, the screen 19 may be a partition plate structured so that the slurry does not pass therethrough.

In the bead mill having this structure, a partition plate that divides the slurry stored in the slurry storage vessel 6 into upper and lower parts is disposed in the position of the screen 19. Further, the rotary shaft 4 passes through an opening portion provided in the partition plate. Also, a component for swirling the slurry is disposed on the rotary shaft 4 below the opening portion. In the example of FIG. 1, the under-screen swirling component 20 is disposed as this component. The under-screen swirling component 20 used to realize the bead mill of this embodiment may take any shape as long as sufficient centrifugal force is formed when the slurry is swirled thereby. However, a structure in which a pattern that promotes swirling is formed on the upper surface of a disc, as shown in FIG. 1, is most preferable. A structure having a plurality of linear projections, as shown in FIG. 6, or conversely a plurality of linear grooves may also be used.

Moreover, when the slurry in the slurry storage vessel 6 is swirled, a vortex may be generated, and as a result, the liquid surface of a central portion of the slurry may fall greatly below the screen 19. As a countermeasure, the swirl prevention plates 18 may be mounted in the interior of the slurry storage vessel 6, as described above. The swirl prevention plates 18 are vertical plates disposed so as to be oriented in the diametrical direction of the slurry storage vessel 6, and are provided in a plurality. An appropriate number of swirl prevention plates is from 3 to 12. By providing the swirl prevention plates 18, the swirling motion of the slurry inside the slurry storage vessel 6 is suppressed so that the beads settle more easily. As a result, the beads can return to the cylindrical container more easily by riding the downward flow through the slurry flow passage 7. The swirl prevention plates 18 are most typically structured so as to be fixed to the side surface of the slurry storage vessel 6, but may be fixed to the bottom surface of the slurry storage vessel 6 instead. Furthermore, although not shown in FIG. 2, the swirl prevention plates 18 are preferably adhered to the swirl prevention tube 22, as shown in FIG. 3. The effect of the motion of the rotary shaft 4 is further mitigated by the swirl prevention tube 22, thereby further suppressing the slurry flow inside the slurry storage vessel 6. The swirl prevention tube 22 is a cylindrical tube, a polygonal tube, or a tube having another shape, and is structured so as to isolate the rotary shaft 4 from the slurry on the periphery thereof in the interior of the slurry storage vessel 6. Further, a hole or the like may be opened in a part thereof.

Note that as an even more preferable embodiment of method 1 of the present invention, the component for suctioning the slurry in the rotary shaft inner flow passage 12, shown in FIG. 1, the screen 19 for filtering the beads and the slurry rotation prevention component, shown in FIG. 2, and so on are disposed in the interior of the slurry storage vessel 6. Moreover, a combination of the structures shown in FIGS. 1 and 2 is also within the scope of the present invention.

Next, using FIG. 3, method 2 of the bead mill according to the present invention will be described. The bead mill having this device configuration includes, as main constituent components, the cylindrical container constituted by the cylinder 2, the upper lid 1, and the lower lid 3, the stirring rotor 5 connected to the rotary shaft 4, and the slit-type bead separation device 23 disposed in the slurry passage port 8 in the lower lid 3, while the slurry storage vessel 6 is additionally disposed in the upper portion of the cylindrical container.

The slurry supplied from the slurry storage vessel 6 to the cylindrical container through the slurry flow passage 7 forms a mixture with the beads and undergoes stirring processing, whereupon the beads are separated before the slurry is discharged from the cylindrical container. In the bead mill of method 2, a bead separation device of a type that separates the beads by passing the slurry through a narrower gap than the diameter of the used beads, such as the slit-type bead separation device 23, is disposed. In the example of FIG. 3, the gap opened between the slit-type bead separation device 23 and the slurry passage port 8 is adjusted so that the beads do not leak therethrough. Note that the bead separation device of the present invention may take any form as long as the slurry passes through a narrow gap formed therein, and a slit-type, a mesh screen-type, a parallel wire-type, or the like may be used.

In the bead mill having the structure described above, when the rotation speed of the stirring rotor 5 while stirring the beads is high or when the slurry is highly viscous, centrifugal force is exerted on the slurry by the rotary motion of the stirring rotor 5, and as a result, the beads may rise through the cylindrical container up to the vicinity of the upper lid 1 and press against the slurry flow passage 7. In the present invention, this problem is dealt with by disposing a component for applying centrifugal force to the slurry above the position in which the stirring rotor 5 is disposed in the cylindrical container. This component is realized by attaching the swirling blades 13 to the upper portion disc 24, as shown in FIG. 3, or the like. This structure is shown in detail in FIG. 6. Here, the swirling blades 13 may be rectilinear or curved, and preferably have a receding angle of 0 to 40 degrees in the rotation direction. Further, the outer peripheral diameter of the swirling blades 13 is preferably larger than the outer peripheral diameter of the stirring rotor 5.

Furthermore, due to the effects of rotation of the rotary shaft 4 and the pumping component 9 and swirling of the slurry in the cylindrical container, the slurry swirls inside the slurry storage vessel 6, but when the swirling becomes violent, a large vortex may be formed such that air is drawn into the cylindrical container from the space in the slurry storage vessel 6. As a result, it may become impossible to continue the processing due to foaming of the slurry, the stirring performed by the stirring rotor 5 may be insufficient, and so on. These problems are dealt with by disposing a rotation prevention component in the slurry storage vessel 6. As shown in the example of FIG. 3, by disposing the swirl prevention plates 18 and the swirl prevention tube 22 in the slurry storage vessel 6, swirling of the slurry can be suppressed, and as a result, air can be prevented from infiltrating the cylindrical container. The swirl prevention plates 18 may also be disposed alone, although this leads to a slight reduction in effectiveness.

In a conventional bead mill, a mechanical sealing structure (typically, a mechanical sealing device) is disposed between the upper portion of the cylindrical container and the rotary shaft. The reason for this is that in order to respond to liquid resistance during the processing in the cylindrical container and pressure loss in the bead separation device, a state in which the interior of the cylindrical container is pressurized by pushing the slurry into the mill using a pump or the like is established, and therefore a sealing mechanism is required on the periphery of the rotary shaft. In the device of the present invention, on the other hand, pressure is applied to the interior of the cylindrical container by the pumping component 9 and so on disposed between the rotary shaft 4, which is a rotating component, and the slurry flow passage 7, which is a fixed component, and therefore differential pressure can be created between the interior and the exterior (in the case of the present invention, the slurry storage vessel 6 is on the exterior) of the cylindrical container without the need for a sealing mechanism. As a result, a mechanical sealing device can be omitted.

### Industrial Applicability

The bead mill according to the present invention can be applied to pulverization processing and dispersion processing of slurry containing a fine powder of ceramics, carbon nanotube, cellulose nanofiber, pigments, inks, paints, dielectric bodies, magnetic bodies, inorganic substances, organic substances, pharmaceuticals, foodstuffs, metals, and so on.

### EXAMPLES

Two of the devices of the present invention (a mill 1 using the centrifugal bead separation method and a mill 2 using the slit-type bead separation device) were manufactured, and processing experiments were performed thereon by introducing beads while varying the component configuration. In a first device (method 1: mill 1), the experiment was performed with six component configurations, namely a mill 1a, a mill 1b, a mill 1c, a mill 1d, a mill 1e, and a mill 1f. The basic structure of the mills 1a to 1e was basically that shown in FIG. 2. The gaps in the mesh of the screen 19 were set at 0.08 to 0.15 mm. In the mill 1d and the mill 1e, a component for adjusting the slurry flow through the gap between the screen 19 and the rotary shaft 4 was disposed. Further, in a mill 1 g, a partition plate was disposed instead of the screen 19, and in order to adjust the slurry flow through the gap between the partition plate and the rotary shaft 4, the under-screen swirling component was disposed. The partition plate was disposed in the same position as the screen 19 of the mills 1b to 1e. In the configuration of the mill 1a, a further experiment was performed to determine a favorable outer peripheral diameter for the swirling blades 13. The mill 1f was the mill shown in FIG. 1. Table 1 shows the specifications of the mills.

TABLE 1

| | | | | | | | | | | |
|---|---|---|---|---|---|---|---|---|---|---|
| | Cylindrical container internal volume | Stirring rotor diameter | Bead dispersion | Swirling blades | Pumping component in slurry passage | Swirl prevention plates | Swirl prevention tube | Slurry swirling component in hollow flow passage outlet | Screen | Bead leakage prevention in screen portion |
| Mill 1a | 200 mL | 44 mm | Centrifugal separation Outer peripheral diameter 44 mm | Yes Diameter 46 mm | Groove type | No | No | No | No | No |
| Mill 1b | | | | | | No | No | No | Yes Gaps 0.08 mm | No |
| Mill 1c | | | | | | Yes 4 plates | No | No | Yes Gaps 0.12 mm | No |
| Mill 1d | | | | | | Yes 6 plates | No | No | Yes Gaps 0.15 mm | Under-screen swirling component |
| Mill 1e | | | | Yes Diameter 50 mm | | Yes 8 plates | No | No | Yes Gaps 0.15 mm | Pumping component Groove type |
| Mill 1f | | | | | | No | No | Slurry rotating tube Diameter 26 mm | No | No |
| Mill 1g | | | | | | No | No | No | Partition plate disposed as alternative | Under-screen swirling component |
| Mill I (comparative example) | | | | No | | No | No | No | No | No |
| Mill 2a | 200 mL | 44 mm | Slit type | Yes Diameter 46 mm | Spiral projection type | No | No | | - | - |
| Mill 2b | | | | Yes Diameter | No | Yes 4 plates | Yes Cylindrical | | - | - |
| Mill II (comparative example) | | | | 50 mm No | Spiral projection type | No | No | | - | - |

In the mill 1a, the swirling blades 13 were disposed but nothing was disposed in the interior of the slurry storage vessel 6, while in the mill 1b, only the swirling blades 13 and the screen 19 were disposed, and in the mill 1c, the screen 19 and the swirl prevention plates 18 were disposed in addition to the swirling blades 13. Further, in the mill 1d, the under-screen swirling component 20 was disposed in addition to the configuration of the mill 1c. The under-screen swirling component 20 was structured as shown in FIG. 6, and the outer peripheral diameter of the blades was 40 mm. Also in the mill 1d, the pumping component 21 was disposed in addition to the configuration of the mill 1c. Furthermore, in the mill 1f, in which a component for rotating the slurry flowing out of the rotary shaft inner flow passage 12 was disposed, the slurry rotating tube 30 shown in FIG. 7 was disposed, and the outer peripheral diameter thereof was set at 26 mm. Note that the outer peripheral diameter of the blades of the centrifugal bead separation device 11 was 44 mm.

Further, a second device (method 2: mill 2) was a bead mill having the contact-type, slit-type bead separation device 23 in the bottom portion of the mill, and basically having the structure shown in FIG. 3. In a mill 2a, the swirling blades 13 were disposed, but neither the swirl prevention plates 18 nor the swirl prevention tube 22 were disposed, while in a mill 2b, both the swirl prevention plates 18 and the swirl prevention tube 22 were disposed in addition to the swirling blades 13. The main specifications are shown on Table 1.

Moreover, as comparative examples, the experiment was also performed using a mill I and a mill II in which none of the swirling blades 13, the swirl prevention plates 18, the swirl prevention tube 22, the screen 19, and so on were disposed in a mill having the same cylindrical container as the mill 1 and the mill 2. The specifications of these mills are also shown on Table 1. In the processing experiment undertaken on the mill 1a to the mill I of method 1, the fluid supplied to the cylindrical container was water, while the fluid supplied to the mills 2a to II of method 2 was water and a highly viscous liquid with a viscosity of 550 mPa · s. The flow rate was set at 8 L/hour.

First, with the device configuration of the mill 1a, the effect on bead leakage of the ratio of the outer peripheral diameter of the swirling blades 13 to the outer peripheral diameter of the component of the centrifugal bead separation device 11 that swirls the slurry was investigated. Six swirling blades 13 with a length of 12 mm and a height of 5 mm were disposed. Note that in a prior experiment conducted by the inventors, the receding angle of the swirling blades 13 was most preferably 10 to 45 degrees, and therefore, in this experiment, the receding angle was set at 30 degrees. An experiment was also performed to determine an appropriate outer peripheral diameter for the swirling blades 13 in the device configuration of the mill 1a. In the device configuration of the mill 1a, the outer peripheral diameter of the component that swirls the slurry is defined as the diameter of the outermost peripheral portion of the component, other than a near-parallel surface (an angle of no more than approximately 30 degrees) to the rotation direction, such as the plate that holds the swirling blades 13. FIG. 8 is a view showing the structure of the centrifugal bead separation device 11 used in this experiment, and in this device, the component that swirls the slurry is the bead separation plates 33. In the example of this case, the outer peripheral diameter of the bead separation plates 33 is preferably taken as the denominator of the outer peripheral diameter ratio. The experiment was performed with the outer peripheral diameter of the swirling blades 13 set within a range of 32 to 65 mm (outer peripheral diameter ratio: 0.73 to 1.48) relative to an outer peripheral diameter of 44 mm for the bead separation plates 33, and using 0.3 mm beads and water set at a flow rate of 7 L/hour. Note that as an experiment condition, an outer peripheral speed of the bead separation plates 33 was set within a range of 4 to 12 m/sec.

As shown in the experiment results on table 2, at an outer peripheral diameter ratio of 0.75 and an outer peripheral speed of 8 m/sec or less in the bead separation plates 33, a very small amount of bead leakage occurred, whereas at an outer peripheral speed of 6 m/sec or less, a considerable amount of bead leakage (1 g/min or more) occurred. Meanwhile, when the outer peripheral diameter was set at 36 mm (outer peripheral diameter ratio: 0.82), only a very small amount of bead leakage occurred at 4 m/sec, and therefore an improvement was observed. Further, when the outer peripheral diameter was set at 40 to 60 mm (outer peripheral diameter ratio: 0.91 to 1.36), no bead leakage was observed. At 65 mm (outer peripheral diameter ratio: 1.36), meanwhile, a very small amount of bead leakage (0.1 g or less over a one-hour operation) occurred at the maximum speed of 12 m/sec. Favorable results were obtained at an outer peripheral diameter ratio of 0.82 or more, and therefore the range is preferably 0.82 to 1.48. A range of 0.91 to 1.36 is even more preferable. On the basis of these results, the outer peripheral diameter of the swirling blades 13 of the mills 1a to 1 g was set at 46 or 50 mm.

TABLE 2

| | | | | | | | | |
|---|---|---|---|---|---|---|---|---|
| Outer peripheral diameter of swirling blades (mm) | 33 | 36 | 40 | 46 | 50 | 56 | 60 | 65 |
| Outer peripheral diameter ratio | 0.75 | 0.82 | 0.91 | 1.05 | 1.14 | 1.27 | 1.36 | 1.48 |
| Minor bead leakage | 8 m/s or less | 4 m/sec | None | None | None | None | None | 12 m/s |
| Bead leakage (1 g/min or more) | 6 m/sec or less | None | None | None | None | None | None | None |

In the mills 1a to 1f and the mill I, the bead leakage situation was checked using beads with diameters of 0.1 mm and 0.3 mm. As regards the processing conditions, the beads were introduced using room temperature water until a filling ratio of 75% was realized in the mill. The experiment was performed while varying the outer peripheral speed of the slurry swirling component (the bead separation plates 33) of the centrifugal bead separation device 11 from 4 to 12 m/sec at intervals of 2 m/sec. The experiment results are shown on Table 3. In the experiment using beads with a diameter of 0.3 mm, bead leakage was observed in the mill I of the comparative example when the outer peripheral speed of the bead separation plates 33 was 4 m/sec.

On the other hand, bead leakage was not observed in any of the mills 1a to 1f, regardless of the conditions. Note that when the outer peripheral speed was 4 m/sec, a very small amount of beads became intermixed in the slurry storage vessel 6 during the processing of the mills 1a and 1b. However, these beads did not flow out to the exterior of the mill. In the mills 1c to 1f, no beads became intermixed in the slurry storage vessel 6.

TABLE 3

| | | Using 0.3 mm beads | | Using 0.1 mm beads | |
|---|---|---|---|---|---|
| | | Bead leakage to mill exterior | Bead accumulation in slurry storage vessel | Bead leakage to mill exterior | Bead accumulation in slurry storage vessel |
| Examples | Mill 1a | No bead leakage | Small amount of accumulation (2 g) at outer peripheral speed of 4 m/s | Leakage after 30 mins at outer peripheral speed of 4 m/s. No leakage at 6 m/s or more | Accumulation of 13 g at outer peripheral speed of 4 m/s |
| | Mill 1b | No bead leakage | Accumulation of 3 g ditto | Small amount of leakage after 50 mins at outer peripheral speed of 4 m/s. No leakage at 6 m/s or more | Accumulation of 15 g |
| | Mill 1c | No bead leakage | None | Very small amount of leakage after 90 mins at outer peripheral speed of 4 m/s. No leakage at 6 m/s or more | Very small amount of accumulation (7 g) at outer peripheral speed of 4 m/s |
| | Mill 1d | No bead leakage | None | No bead leakage | Accumulation of 5 g ditto |
| | Mill 1e | No bead leakage | None | No bead leakage | Accumulation of 4 g ditto |
| | Mill 1f | No bead leakage | None | No bead leakage | Accumulation of 2 g ditto |
| | Mill 1g | No bead leakage | None | No bead leakage | Accumulation of 1.5 g ditto |
| Comparative example | Mill I | Very small amount of leakage at outer peripheral speed of 4 m/s | Small amount of accumulation (11 g) at outer peripheral speed of 4 m/s | Leakage after 15 mins at outer peripheral speed of 6 m/s. Leakage from the start at 4 m/s | Accumulation of 16 g at outer peripheral speed of 6 m/s |

Note) Outer peripheral speed: rotation speed of outer peripheral portion of bead separation plates 33

In the experiment using beads with a diameter of 0.1 mm, intermixing of the beads in the slurry storage vessel 6 was observed in all mills during processing with the outer peripheral speed of the bead separation plates 33 set at 6 m/sec or less, and in the experiment performed on the mill I of the comparative example, beads leaked to the outside of the device from the slurry storage vessel 6 15 minutes after the start of the processing at 6 m/sec. In the experiment performed on the mill 1a, on the other hand, bead leakage did not occur until the outer peripheral speed of the bead separation plates 33 reached 6 m/sec, and at 4 m/sec, a small amount of beads leaked to the outside of the device from the slurry storage vessel 6 30 minutes after the start of the processing. At this point in time, as shown on Table 2, a considerable amount of beads had accumulated in the interior of the slurry storage vessel 6.

Hence, the beads showed a tendency to accumulate in the interior of the slurry storage vessel 6, and in the mill 1a in which only the swirling blades 13 were disposed, although an effect for preventing bead leakage was achieved, the effect was somewhat limited. In the processing of the mill 1b, no bead leakage from the slurry storage vessel 6 was observed during processing performed with the outer peripheral speed of the bead separation plates 33 set at 6 m/sec or more, and even during the processing performed at 4 m/sec, only a very small amount of leakage was observed 50 minutes after the start of the processing. Hence, by disposing the screen 19, it was possible to prevent bead leakage. Note, however, that a small amount of beads had accumulated in the slurry storage vessel 6 at the end of the processing.

In the experiment performed on the mill 1c, no bead leakage from the slurry storage vessel 6 was observed during the processing performed with the outer peripheral speed of the bead separation plates 33 set at 6 m/sec or more, and even during the processing performed at 4 m/sec, only a very small amount of leakage was observed 90 minutes after the start of the processing. Hence, by disposing the swirl prevention plates 18 in addition to the screen 19, it was possible to prevent suspended bead leakage of the beads in the slurry storage vessel 6. The amount of beads remaining the slurry storage vessel 6 following all of the processing was a very small amount. The reason for this is believed to be that since swirling of the slurry in the slurry storage vessel 6 is reduced such that suspension of the beads is suppressed, it becomes easier to feed the beads to the cylindrical container together with the slurry using the pumping component 9. Note that the reason why a small amount of bead leakage occurred is believed to be that since the under-screen swirling component 20 and so on were not provided, the beads leaked upward through the space between the screen 19 and the rotary shaft 4.

In the experiments performed on the mill 1d and the mill 1e, no bead leakage was observed during all of the processing performed with the outer peripheral speed of the bead separation plates 33 set at 4 to 12 m/sec. This was due to the centrifugal effect of the under-screen swirling component 20 and the effect of the downward slurry flow formed by the pumping component 21. Moreover, in the processing performed on the mill 1d and the mill 1e, the amounts of beads remaining in the slurry storage vessel 6 following the processing performed on the mill 1d and the mill 1e were much smaller than in the processing performed on the mills 1a, 1b, and I, while the amount of accumulated beads was slightly smaller than in the processing performed on the mill 1c.

In the experiment performed on the mill 1f, an effect of sucking out the slurry in the rotary shaft inner flow passage 12 was obtained by the slurry rotating tube 30, thereby stabilizing the flow of slurry into the centrifugal bead separation device 11 so that bead leakage into the slurry storage vessel 6 was smaller than in the processing performed on the mill I of the comparative example and also the processing performed on the mills 1a to 1e.

The experiment performed on the mill 1g is an example in which the partition plate through which the slurry does not pass was disposed instead of the screen 19. A component having the structure shown in FIG. 6 was disposed on the rotary shaft 4 as the under-screen swirling component 20. The diameter of the under-screen swirling component 20 was set at 44 mm, i.e., 1.0 times the diameter of the bead separation plates 33 of the bead separation device, making it possible to generate enough centrifugal force to push out the beads in an outward direction, and as a result, no beads leaked upward from the slurry storage vessel even when all of the slurry passed through the space between the rotary shaft 4 and the partition plate. In an experiment performed by the present inventors, when the ratio of the diameter of the under-screen swirling component 20 to the diameter of the bead separation plates 33 was 0.7 or less, sufficient centrifugal force could not be secured, and a very small amount of bead leakage occurred. Further, when the ratio was 1.4 or more, the slurry flow in the interior of the slurry storage vessel 6 became excessive, leading to the formation of a vortex, and as a result, foaming of the slurry occurred.

In the mills 2a and 2b and the mill II, the processing experiment was performed using 0.5 mm beads together with water and highly viscous slurry with a viscosity of 550 mPa · s. The diameter of the swirling blades 13 of the mill 2b was 50 mm, which is larger than the diameter of the stirring rotor 5, and it was therefore possible to form a sufficient downward flow in the interior of the slurry flow passage 7 by means of the slurry suctioning effect generated by the centrifugal force of the swirling blades 13. Accordingly, the pumping component 9 was omitted. Note, however, that in order to increase the passage resistance in the slurry flow passage 7, a cylinder (with no grooves or projections) having the same diameter as the pumping component 9 was disposed.

These experiment results are shown on Table 4. In the mill II of the comparative example, when the outer peripheral speed of the stirring rotor 5 was set at a high speed of 8 m/sec or more, the phenomenon whereby the beads are pushed against the upper lid 1 by the centrifugal force created by the stirring rotor 5 occurred. As a result, the beads entered the slurry flow passage 7 and then entered the slurry storage vessel 6. The flow of slurry traveled from the slurry storage vessel 6 toward the cylindrical container, and therefore no beads were intermixed in the slurry after the processing. However, a problem occurred in that the pumping component 9 became worn. Moreover, when the outer peripheral speed of the stirring rotor 5 was 10 m/sec or more during the processing using water and 8 m/sec or more during the processing using highly viscous slurry, a large vortex was formed in the slurry storage vessel 6, causing air to enter the mill, and as a result, slurry foaming occurred.

In the mill 2a, the disc 24 and the swirling blades 13 were disposed as components for swirling the slurry in the upper portion of the mill, and by rotating the slurry near the upper lid 1, the beads were prevented from approaching the slurry flow passage 7. Hence, the pumping component 9 did not become worn, and the beads did not flow back to the slurry storage vessel 6. However, the effects of swirling of the slurry were not resolved, and therefore, when the outer peripheral speed of the stirring rotor 5 was 10 m/sec or more during the processing using water, air entered the cylindrical container from the slurry storage vessel 6, causing the slurry in the cylindrical container to foam, and as a result, the slurry flow deteriorated, making the processing impossible. In the mill 2b, on the other hand, both the combination of the swirling blades 13 and the disc 24 serving as the slurry swirling device and the swirl prevention plates 18 and swirl prevention tube 22 for preventing rotation were disposed, and therefore breakage of the cylinder and the foaming phenomenon did not occur in any of the processing.

TABLE 4

| | | Outer peripheral speed of stirring rotor 5 set at 8 to 12 m/s | | |
|---|---|---|---|---|
| | | Wear on pumping component 9 | Bead leakage into slurry storage vessel 6 | Air infiltration into cylindrical container |
| Examples | Mill 2a | None | None | Water: Yes at 10 m/s or more |
| | | | | High viscosity: Yes at 8 m/s or more |
| | Mill 2b | None | None | None |
| Comparative example | Mill II | Wear at all speeds | Small amounts of leakage at all speeds | Water: Yes at 10 m/s or more |
| | | | | High viscosity: Yes at 8 m/s or more |

As described above, with the bead mill of the present invention, slurry processing can be performed with no bead leakage even without a mechanical seal disposed in a conventional bead mill.

Reference Signs List

| | |
|---|---|
| 1 | Upper lid |
| 2 | Cylinder |
| 3 | Lower lid |
| 4 | Rotary shaft |
| 5 | Stirring rotor |
| 6 | Slurry storage vessel |
| 7 | Slurry flow passage |
| 8 | Slurry passage port |
| 9 | Pumping component |
| 10 | Slurry communication flow passage |
| 11 | Centrifugal bead separation device |
| 12 | Rotary shaft inner flow passage |
| 13 | Swirling blade |
| 14 | Shaft driving pulley |
| 15 | Belt |
| 16 | Motor-side pulley |
| 17 | Motor |
| 18 | Swirl prevention plate |
| 19 | Screen |
| 20 | Under-screen swirling component |
| 21 | Pumping component |
| 22 | Swirl prevention tube |
| 23 | Slit-type bead separation device |
| 24 | Disc |
| 25 | Columnar portion |
| 26 | Spiral projection |
| 27 | Groove |
| 28 | Keyhole |
| 29 | Swirling slurry discharge component |
| 30 | Slurry rotating tube |
| 31 | Upper fixing disc |
| 32 | Lower fixing disc |
| 33 | Bead separation plate |

1. A bead mill in which a rotary shaft is disposed in a vertical direction, a slurry storage vessel is disposed above a container in which stirring processing is performed on beads and slurry, a slurry passage port is disposed in a lower portion of the container, and a slurry flow passage through which the slurry can pass is disposed between an upper lid of the container and the slurry storage vessel, and in which the rotary shaft extending from above the slurry storage vessel into the container through a space in the slurry flow passage, and a structure that causes the slurry in the slurry flow passage to flow downward being disposed on the rotary shaft, wherein
a flow promoting component that swirls the slurry as the rotary shaft rotates is disposed in a higher position than either an uppermost portion of a stirring rotor that is fixed to the rotary shaft in an uppermost portion of the cylindrical container or an upper portion of a centrifugal bead separation device fixed to the rotary shaft.

2. The bead mill according to claim 1, which is structured such that the slurry is supplied through the slurry passage port in the cylindrical container, the centrifugal bead separation device and a component that causes the slurry in the slurry flow passage to flow downward are disposed on the rotary shaft, a hollow passage through which the slurry that has passed through the centrifugal bead separation device flows out into the slurry storage vessel is disposed in the interior of the rotary shaft, and the slurry flows upward through the hollow passage.

3. The bead mill according to claim 2, wherein a flow passage that causes the slurry to flow in a direction away from the rotational center of the rotary shaft so as to discharge the slurry into the slurry in the slurry storage vessel is fixed to a slurry outlet of the hollow passage formed in the rotary shaft.

4. The bead mill according to claim 2, wherein a screen that filters the beads from the slurry is disposed in the slurry storage vessel.

5. The bead mill according to claim 4, wherein a component that causes the slurry in a space between the screen and the rotary shaft to flow downward and/or a component for swirling the slurry below the outside screen is disposed.

6. The bead mill according to claim 2, wherein a partition plate that divides the slurry stored in the slurry storage vessel into upper and lower parts is disposed, the partition plate has an opening portion through which the rotary shaft passes vertically, and a component for swirling the slurry is disposed on the rotary shaft below the opening portion.

7. The bead mill according to claim 1, which is structured such that a slurry discharge port is disposed in a lower lid of the cylindrical container, and after the slurry is supplied from the slurry storage vessel into the cylindrical container through the slurry flow passage, the beads are separated by a contact-type bead separation device, whereupon the slurry is discharged from the slurry discharge port.

8. The bead mill according to claim 1, wherein a component for preventing swirling of the slurry is disposed in the slurry in the slurry storage vessel.

9. The bead mill according to claim 8, wherein the component for preventing slurry rotation, disposed in the slurry storage vessel, is constituted by a plurality of vertical direction plates arranged so as to divide the interior of the slurry storage vessel in a circumferential direction.

10. The bead mill according to claim 8, wherein the component for preventing slurry rotation, disposed in the slurry storage vessel, is constituted by a combination of a structure that surrounds the rotary shaft and a plurality of vertical direction plates that divide the interior of the slurry storage vessel in a circumferential direction.

11. The bead mill according to claim 2, wherein the diameter of an outermost peripheral portion of the flow promoting component that swirls the slurry is at least 0.82 times that of an outermost peripheral portion of a component of the centrifugal bead separation device that swirls the slurry.
